(19) United States
(12) Patent Application Publication
(10) Pub. No.: US 2017/0293888 A1
(43) Pub. Date: Oct. 12, 2017

(54) SYSTEM AND METHOD FOR MANAGING VETERINARY DATA

(71) Applicant: GREENLINE, LLC, Franklin, TN (US)

(72) Inventor: Phillip G. Shackelford, Memphis, TN (US)

(73) Assignee: GREENLINE, LLC, Franklin, TN (US)

(21) Appl. No.: 15/528,489

(22) PCT Filed: May 22, 2014
(86) PCT No.: PCT/US14/39248

§ 371 Date: May 19, 2017

Related U.S. Application Data
(60) Provisional application No. 61/826,304, filed on May 22, 2013.

(51) Int. Cl. G06Q 10/10; G06Q 50/22; G06Q 30/02

(52) U.S. Cl. CPC G06Q 10/10; G06Q 30/0224; G06Q 50/22; G06Q 30/01

(57) ABSTRACT

An approach for a veterinary management system server that enables management of a practice, vendors, pet, and pet owner information while gathering metrics and providing reports in addition to providing marking services to the practice and vendors.

### I. FIELD OF INVENTION

The invention relates generally to data management systems and, more particularly, to data management systems for veterinarians, pet-health providers, and pet owners.

### II. RELATED APPLICATION

This application claims priority to U.S. Provisional Patent Application No. 61/826,304, titled “SYSTEM AND METHOD FOR MANAGING VETERINARY DATA,” filed on May 22, 2013, which is incorporated by reference herein.

### III. BACKGROUND OF THE INVENTION

Veterinarians, veterinarian's staff, and consumers have employed a 12 step process that has been established and used by the industry leaders in products sold by veterinarians (MERIAL and BAYER) for over 15 years: Step 1—offer client product coupon/offer; Step 2—print a second paper copy of the transaction invoice; Step 3—staple to the appropriate (in date) manufacturer coupon (e.g., Frontline buy 6 doses get 2 free or Heartgard® buy 12 get a $10.00 rebate); Step 4—staff either hand fill-in the coupon or stamp or print and affix a client label; Step 5—staff hand write in their staff reward number; Step 6—separate coupons with invoices (proof of purchase) into types; Step 7—pack in postage paid envelopes; Step 8—mail to 3^{rd} party, Step 9—3^{rd} party manual data entry, manufacturer receives report; Step 10—manufacturer or 3^{rd} party sends via print and mail to client or manufacturer applies free dose credit to vet practice statement (this can be random as received in batches and therefore vet has no way to reconcile free doses out to free dose credits in), alternatively Bayer would send reimbursement doses to the vet (which they also have difficulty reconciling);, Step 11—Staff receives a $1 to $2 staff reward on a debit card; and Step 12—Staff must access a web portal to reconcile their submitted coupons/offers to rewards. This 12-step process (sometimes more) can take 4-12 weeks or longer, during which the veterinarian is basically extending credit to the manufacturer for the products, such as tubes of heartworm medicine (which could be as much as $10-15 per tube).

Some Manufacturers like ELANCO and NOVARTIS utilize a different system. Their approach requires the vet practice to print a 2^{nd} invoice in some cases and provide the pet owner/client a coupon with instructions to go to a web-portal and complete some required fields, data entry and then print, mail, fax and/or scan their proof of purchase (invoice) and submit them. The vet practice or pet owner then must wait 2-4 weeks or more to receive a paper letter in the mail with a rebate check. This is a complicated process as well, and results in only 1 in 10 pet owners completing the process and of those, only 40-60% complete it accurately.

Thus, there is a need for a streamlined approach to servicing clients that reduces the complexity and repetitive entry of data.

### IV. SUMMARY

A system for managing data for veterinary business owners and their clients is provided. A profile management module manages a set of user profiles. Individual user profiles in the set of user profiles are respectively associated with a veterinarian, pet owner, manufacturers or provider of veterinary or other pet-health products and services. User profile information is entered into the system, either by a workstation or mobile device, through a practice management software program and stored remotely in a database server. An analytics application module evaluates the stored data and determines what stored information should be transmitted to a particular user based on their user profile information. The stored information may include veterinary or other pet-health product offers, rebates and incentives; pet, pet owner, and veterinarian information; and other related information.

A computer-implemented method of veterinary-related data management and processing is also provided. A user profile is created via a mobile application or workstation. The user profile may consist of information relating to a pet, pet owner, veterinarian, manufacturer, or provider of veterinary products and services. The user information is stored in a database. An analytics application evaluates the user information and transmits data to a user based on his or her user profile. The transmitted data may include veterinary or other pet-health product offers, rebates and incentives; pet, pet owner, and veterinarian information; and other related information.

### V. DESCRIPTION OF FIGURES

The invention may be better understood by referring to the following figures. The components in the figure(s) are not necessarily to scale, emphasis instead being placed upon illustrating the principles of the invention. In the figure(s), like reference numerals designate corresponding parts throughout the different views.

FIG. 1 is a block diagram of a veterinary management system server coupled to a local area network and the internet that is able to communicate with supplier in accordance with an example implementation of the present invention.

FIG. 2 is a block diagram of an example of an embodiment of a data management system of the present invention.

FIG. 3 is a block diagram 300 of a plurality of modules executed by the controller 114 of FIG. 1 that make up the software that is executed on the veterinary management system server 102 of FIG. 1.

FIG. 4 is an illustration of an approach of a pet owner using a rebate with the veterinary management system server of FIG. 1 in accordance with an example implementation.

FIG. 5 is an illustration of a flow diagram of an approach for processing a patient's visit with the veterinary management system server of FIG.1 in accordance with an example implementation.

FIG. 6 is an illustration of a flow diagram of generating reports in the veterinary management system server via an analytics module in accordance with an example implementation of the invention.

FIG. 7 is an illustration of the digital coupon/rebate approach in a veterinary practice with a veterinary management system server of FIG. 1 in accordance with an example implementation.

FIG. 8 is an illustration of a flow diagram 800 of an approach for providing promotional offers to pet owners in accordance with an example implementation.

FIG. 9 is an illustration of a commercial implementation of the veterinary management system server of FIG. 1 in accordance with an example implementation of the present invention.

### VI. DESCRIPTION OF INVENTION

The description of implementations below is presented for purposes of illustration. It is not exhaustive and does not limit the claimed invention to the precise forms disclosed. Modifications and variations are possible in light of the description below, or may be acquired from practicing the invention.

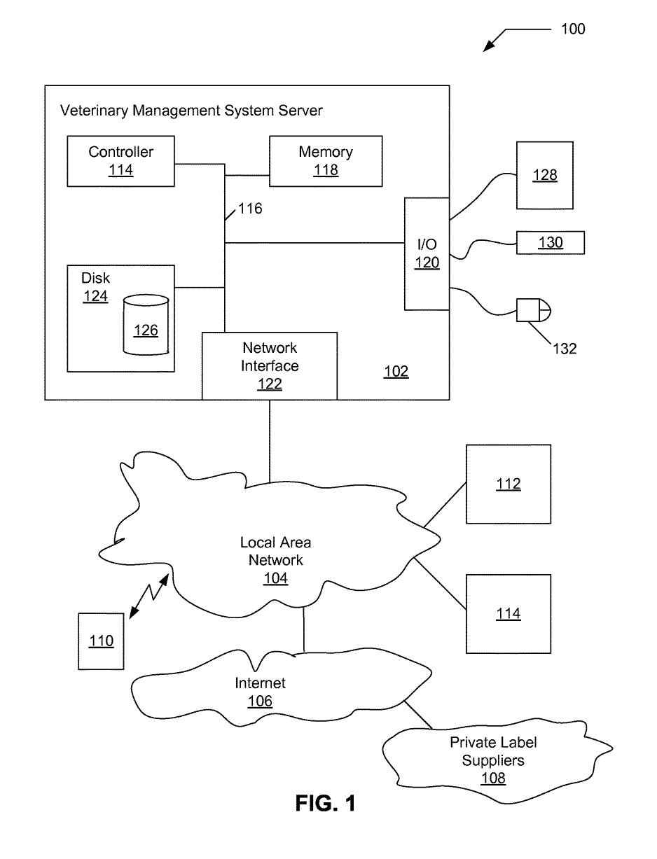

In FIG. 1, a diagram 100 of veterinary management system server 102 coupled to a local area network (LAN) 104 and the internet 106 that is able to communicate with supplier 108 and others 110 either wirelessly or wired in accordance with an example implementation of the present invention is depicted. The LAN 104 may also connect additional devices in an office or area, such as workstation 112 and workstation 114. The veterinary management system server 102 may have a controller 114 coupled to one or more buses (i.e. data bus, address, bus, serial bus, video bus . . . ) represented by bus 116. Bus 116 may also be coupled to one or more memories, for example, memory 118, and input/output (I/O) interface 120, network interface 122, and disc interface 124. Disc interface 124 may be coupled to one or more disc drives that may provide storage for database 126. The I/O interface 120 may connect to a video device/monitor 128, keyboard 130, and mouse 132. In other implementations, different types of I/O devices, fewer I/O devices, or more I/O device may be employed.

The controller 114 may be implemented as a single microprocessor, multi-core microprocessor, application-specific integrated circuit (ASIC), digital signal processor, or a collection of electrical elements functioning as a state machine. The memory 118 may be volatile and/or non-volatile memory, including ROM, PROM, EPROM, EEPROM, RAM DRAM, SRAM, or other addressable memory. The database 126 is depicted as being stored within the veterinary management system server 102, but in other implementations, the database 126 may be stored externally to the veterinary management system server 102, or distributed among different devices accessible via the LAN 104 and/or internet 106. Examples of databases include Microsoft Access, SAS, and SQL (including mySQL) databases. The database is preferably a relational database, such as mySQL, but in other implementations other types of databases may be used (including flat files). The network interface 122 and network is preferably an 802.3 internet type network. But, in other implementations other types of networks may be used, including token ring networks. Workstations 112 and 114 are typically implemented as networked desktop computers, such as those manufactured by DELL and APPLE. But, other client devices may also serve as workstations 112 and 114. The client devices may be any type of computing device that is able to be configured to communicate via a network, e.g. a packet-switched network such as the internet. Client devices may include, for example, desktop computers, laptop computers, tablet computers, palmtop computers, mobile telephones, videogame consoles, network-enabled televisions, and the like.

Wireless device 110 may be a wireless device such as a smart phone or tablet (e.g., ANDROID, IPHONE/IPAD) or even a desktop computer. Private label suppliers 108 may include a supplier that has workstations/servers connected at their location or company to the internet 106 accessing the veterinary management system server 102 via the internet 106 and LAN 104 in the current example implementation.

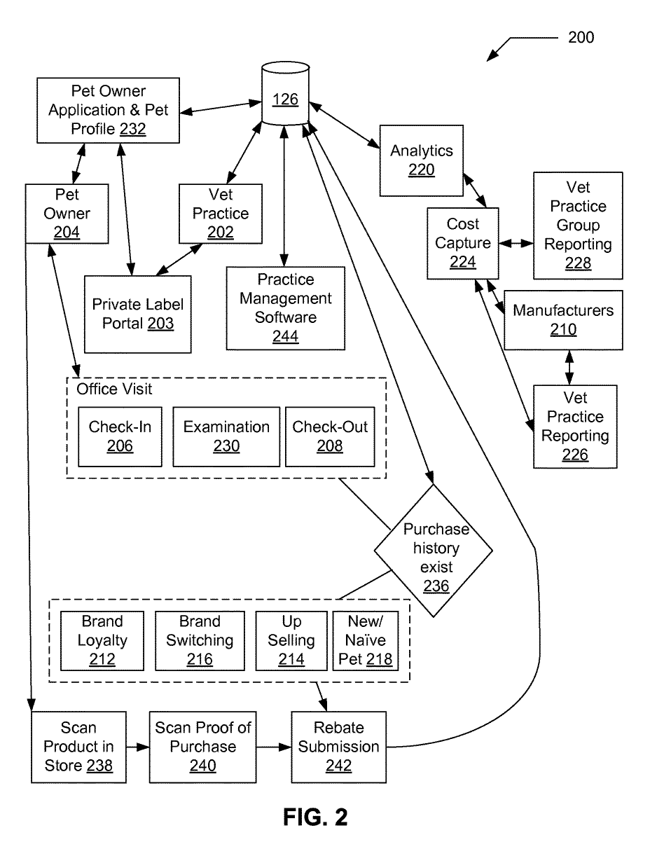

FIG. 2 is a block diagram 200 of an example implementation of the veterinary management system server 102 of FIG. 1. As shown the system may consist of a veterinary management system server that enables smart devices and/or an in-office workstations to be established through a network connection over the internet and/or LAN (in some implementations a virtual private network (VPN) may be employed) connections with the veterinary management system server 102 and access an intelligent database 126.

This allows the veterinary user 202 and suppliers 210 to input their desired offers using the private label portal 203, rebates and incentives, to motivate pet owning consumers to purchase pet products or refill products and purchase veterinary related services while tracking consumer purchase history 236. Users may include pet-health manufacturers, veterinarians, vet business owners and staff, other pet health providers and pet owners 204. The offers, rebates, incentives, etc . . . may be automatically prompted at an office visit at check-in 206 and/or check-out 208, when pet owning consumers 204 are most likely to make a purchase and will include, but not be limited to, brand loyalty 212, up-sell 214, brand switching 216 and naïve pet (i.e, a pet that has not been to the veterinary practice before or has no history for certain medications, no purchases in the last 7 or 13 months, or no heartworm or flea/tick preventive invoiced during the annual visit) 218. The veterinary management system server 102 and its interfaces allow administrators to make adjustments to information and offers and receive data. It also provides a secure means of delivery of pet owner information, clinic information, pet medical information and transactional information associated with offers, rebates, and incentives 212-218 via VPN and secure/encrypted communication. Users have flexibility to manage their operation and administrative cost 224, create greater operational efficiency, including reduction of paper waste. Additionally, the user's ability to make sense of analytics 220 by monitoring, collecting and indexing, creates an opportunity to improve their business operations and save money.

This allows veterinary practice reporting 226 or veterinary practice groups reporting 228, as users, to deliver their preferences, to the appropriate manufacturer and other product and service offers to the appropriate pet owner, at the best possible timing, automatically prompted at practice check-in 206 and/or check-out 208 when pet owning consumers are most likely to make a purchase when bringing their pets in for an vet exam 230, and with continuity across practice staff and consistent messaging, as well as the appropriate scheduled reminders and information. Preferences may be set in a user profile and accessed with the use of a role-based permissions system that gives users individual sign-in credentials. The veterinary management system server 102 provides a secure means by which to deliver the pet owner and transaction information to the aligned manufacturer 210 and/or other animal health related company, and receive metric reporting, results and compliance information to reconcile same. Veterinarians and medical staff will have the ability to set reminders, share information, observations and evaluations and editing of same, online through a web interface, disallowing the editing of these fields from the mobile device or other workstation (such as 112 or 114 of FIG. 1).

The veterinary management system server 102 allows pet owners 204 and clients, as users, to check for and receive offers for their pet 232, obtain storage and portability of their pet's information, align to a veterinary practice, receive reminders, confirm and change appointments, and share information included in their pet's profile all via their mobile device 110. Data may be transferred to and from the mobile device 110 by synchronizing (Syncing) to an online data warehouse or database 126. The mobile devices allow for greater user reach and frequency, storage and portability of information. Users may upload pet specific information, update history, check for and receive information on their mobile device.

Data may be extracted from the veterinary management system server 102, transferred securely and will be stored in a secure data warehouse, data including, but not limited to: electronic transactional data, dispensing data, sales information comparison to inventory on hand information indicating consumption and share by clinic and where possible share and dispensing by veterinarian from aligned veterinary users. In addition, certain key points of interest data related to product and service sales and cost information may be extracted to provide certain users desired reports. Users of these specific individual practice levels 226, group 228, regional and national, benchmark, compliance and other management reports are able to access them to gain directional sales and marketing information through a web portal.

The veterinary management system server 102 may communicate with legacy practice management software 244, (e.g. Impromed® Infinity and Cornerstone®) that has been previously installed at a veterinary office site provided interfaces have been provided by that software or are able to be created. The legacy practice management software 244 may be executed on the same server hardware as the veterinary management system server 102 or on independent hardware apart from the veterinary management system server 102. In the current example implementation, the practice management software 244 is depicted as being separate.

Pet owners 204 may also use their smart devices when purchasing products 238, 240 and for the submission of rebates 242 to the veterinary management system server 102. The veterinary management system server 102 may then further process the rebate and provide it to the manufacturers 210. In other implementations, other devices in addition to smart devices may be used with the veterinary management system server 102. An additional benefit of the veterinary management system 102 is that pet owners 204 benefit from better connectivity with their veterinarian's practice and are more likely to comply/adhere with recommendations for products like heartworm and flea/tick preventives. The veterinary management system 102 may provide reminders regarding medication use and refilling the medications. Further, targeted/specific offers, rebates, and coupons may be aligned with the reminders and a pet owner's purchase history.

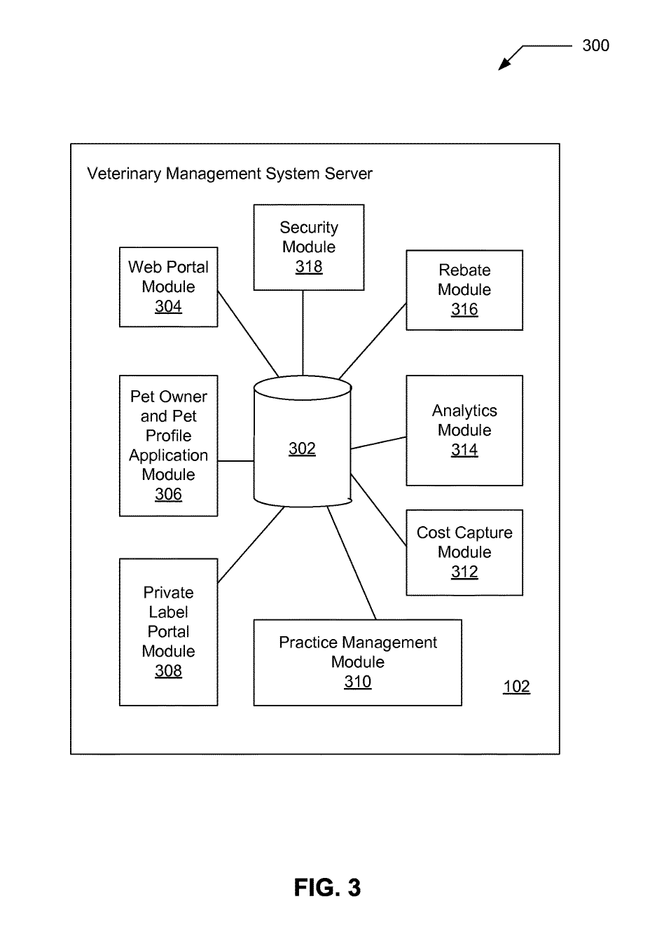

Turning to FIG. 3, a block diagram 300 of a plurality of modules executed by the controller 114 of FIG. 1 that make up the software that is executed on the veterinary management system server 102 of FIG. 1 is depicted. The database module 302 implements the relational database that is accessed by the web portal module 304, pet owner application module 306, private label module 308, practice management module 310, cost capture module 312, analytics module 314, and rebate module 316. The different modules may communicate between each other and database module 302 over bus 116 of FIG. 1. The modules may be implemented in an operating system such as Linux, UNIX, MICROSOFT' s Windows, and APPLE's OS operating systems.

The database module 302 may be a collection of software instructions that when executed creates a database having a predefined schema. The database module 302 typically provides tools for creating and managing the predefined schema. Further, the database module 302 defines interfaces for accessing and storing data in the database. Examples of some of the database fields that may be defined in the predefined schema include: pet identifiers, pet owners identifiers, purchase history, product offer history, date of last visit, rebates given, pet medical history, veterinary and billing information, etc . . . .

The pet owner application module 306 may be a collection of software instructions that when executed results in the pet owner being able to access appointment schedules, pet's profile, their profile, and receive additional information and promotions. The pet owner application module 306 may communicate with the web portal module 304 to provide access to the pet owner application module 306 from internet-connected devices, such as smart device 110 of FIG. 1. The pet owner application module 306 may also communicate with other modules as the other modules need to provide additional information/data and receive data from the pet owner.

The web portal module 304 may be a predefined website using HTML, JAVA, Adobe® Flash® and/or other known website building software and software tools (e.g. Dreamweaver) that is commonly used to implement websites. The web portal module provides the interface between the user and other modules, including the database module 302. In some implementations, part of the website may access or reside in the database module 302.

The private label portal module 308 may be a predefined website HTML, JAVA, Adobe® Flash® and/or other known website building software and software tools (e.g. Dreamweaver that is commonly used to implement websites. In other implementations, the private label portal module 308 may be implemented in conjunction with the web portal module 304. The private label portal module 308 enables the private label suppliers to market to the pet owners via the pet owner application 306 and web portal module 304. The private label portal module 308 enables coupon codes and other offers to be provided to the pet owners when they are accessing the pet owner application 306. In other implementations, the private label portal module 308 may access email information for the pet owners stored in the database module 302 and directly market to the pet owner. Such marketing may be directed to pet owners based upon analytics contained within the veterinary management system server 102.

A practice management module 310 may be an interface with the external practice management software, such as 244 of FIG. 2, and provide billing, scheduling, pet owner data, and pet data to the veterinary management system server 102. In the current example implementation, the practice management software 244 provides and/or duplicates that data that it has into the database module 310. The data may then be synched between the two systems 102 and 244 keeping both current. In other implementations, the practice management module 310 may be completely implemented within the veterinary management system server 102.

A cost capture module 312 may be a collection of software instructions that when executed results in the generation of predefined reports of charge and cost data contained in the database 126. The cost capture module 312 may capture cost and/or charges. Examples of such reports include procedure performed, items sold, items used in procedures, rebates, and practice expenses. These reports may also reference revenue and income for providing the services and sales. Additionally, these reports may provide direct information about cost and/or charge capture.

An analytics module 314 may be a collection of software instructions that when executed results in analytics being collected related to not only cost, but number of pets, patients, what is sold, date and time of activities (sales, procedures, appointments, etc . . . ). The collected analytics, which may include metrics (partially processed analytics), may be reported via predefined reports associated with the database module 302 or user defined reports associated with the database module 302. The reports may be accessed via the web page portal module 304 or directly from the database module 302.

A rebate module 316 may be a collection of software instructions that when executed results in rebate information being processed and/or sent to a manufacturer for payment. The rebate module 316 may also process coupons or other promotions from a manufacturer or veterinary practice. The rebate module 316 may communicate with the database module 302, security module 318, pet owner application 306, and the web portal module 304. The rebate module 316 receives rebate information either from the pet owner application or the practice management module 310. In other implementations, the rebate module 316 may also receive rebate information via a direct interface. Processed rebates may be either periodically or immediately transmitted from the veterinary management system server 102 to a manufacturer for further processing and payment. The rebate module tracks and records rebates that are being processed, sent, and complete. The analytics module 314 may be able to track data associated with the processing of the rebates, such as the date and time a rebate was processed, sent, and complete, and the amount of outstanding rebates at each step of the processing.

A security module 318 may be a collection of software instructions that when executed results in user authentication, encryption of user passwords, and assignment of user and group permissions for using and conducting different operations on and within the veterinary management system server 102. The security data will generally be saved in an encrypted format, similar to passwords in a UNIX file system. Analytics may be kept to record security data usage, such as failed login attempts, attempted unauthorized report processing, and similar detected attempted security breaches.

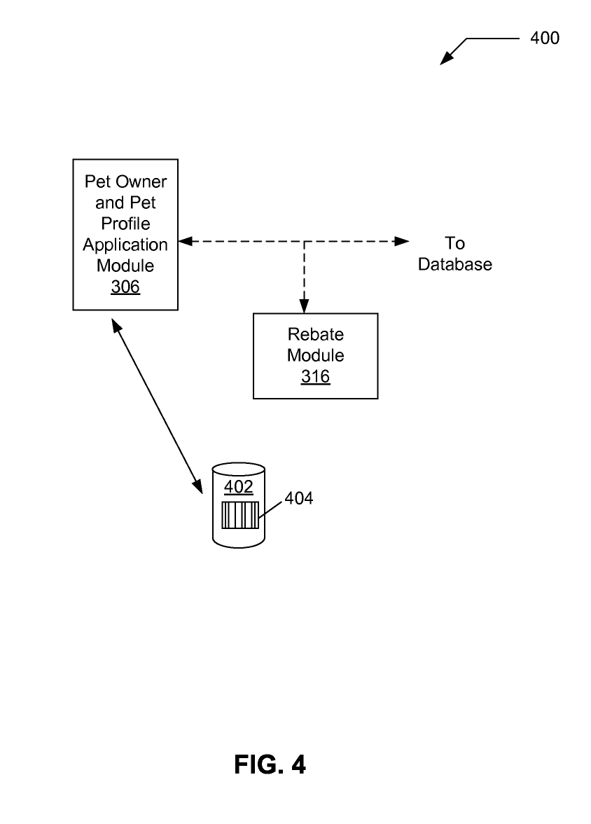

In FIG. 4, an approach of a pet owner using a rebate with the veterinary management system server 102 of FIG. 1 is illustrated in accordance with an example implementation. A pet owner using a smart device 110 scans or takes a picture of the bar code 404 on or other similar code on product 402. The veterinary management system server 102 then transfers the information via the web portal module 304 to the pet owner application module 306 where the rebate information may be formatted for storage in the database module 302. The pet owner application module 306 may then notify the rebate module 316 that a rebate has been received and its data stored by the database module 302. The rebate module 316 then processes the rebate as previously described.

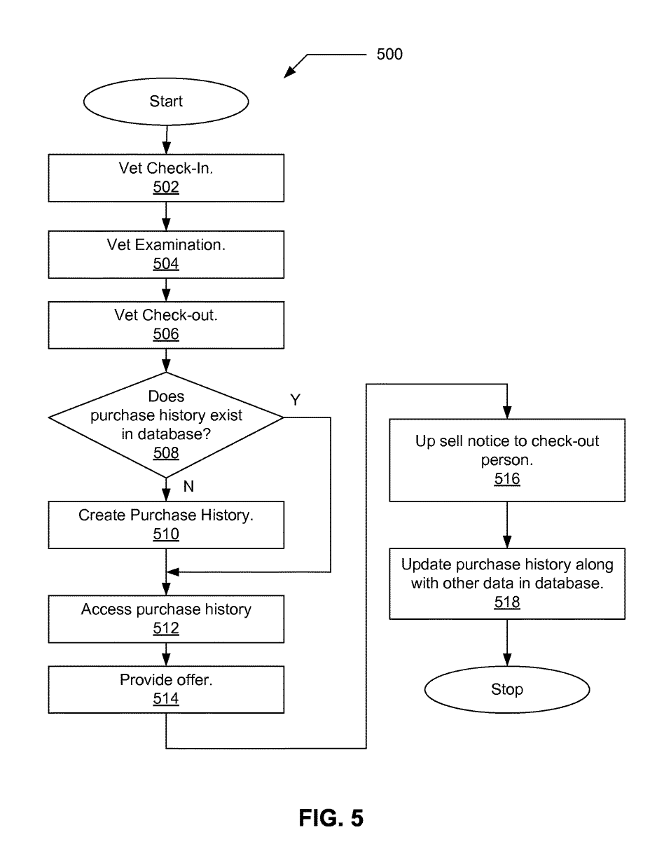

Turning to FIG. 5, a flow diagram of an approach for processing a patient's visit with the veterinary management system server 102 of FIG. 1 is illustrated. The approach starts when a patient checks in at the check-in counter in the veterinary office 502. The appointment that is being checked in may have been previously made via the pet owner application module 306 using the web portal module 304. In other implementations, the practice management software 244 may be accessed to retrieve the appointment information at check-in. If a record of the pet owner or pet does not exist and has not previously been setup via the pet owner application module 306, it may be set up at a workstation 112 coupled to veterinary management system server 102. In due course, a veterinary examination of the pet or animal occurs 504. During the examination, the veterinarian may enter data into a workstation associated with the diagnoses, tests, and equipment used during the examination via (directly and/or indirectly) the practice management module 310. The pet owner then checks out 506 and in many cases pays their bill. During checking out, a workstation is used in the veterinary office and the veterinary management system server 102 checks if the pet owner has a purchase history 508. If a purchase history does not exist 508 and there is no designated/desired product and/or service that has been selected by the veterinary user (pet owner) on the invoice, then a purchase history is created 510 in the database 126. Once the purchase history is created 510 or if it already exist 508, then it is accessed 512. Based upon the purchase history, an offer is provided to the pet owner 514. The offer may be directed at reinforcing brand loyalty, attempt to switch the pet owner from one brand to another, or up sell an item or add-on (item, product, and/or service) 516. For example, an offer for parasite prevention might be offered at predetermined times of the year to animals that have previously had issues or bought products before. This offer would be displayed at the workstation where the check-out was occurring. Another example is if a two month supply of heartworm medication has been bought previously, a notice may be provided at the workstation to up sell or offer a twelve month supply. The purchase history and other data would then be updated 518 in the database 126 via the database module 302 to reflect that an offer was made and the result of the offer. Additional information regarding the visit may also be stored in the database 126.

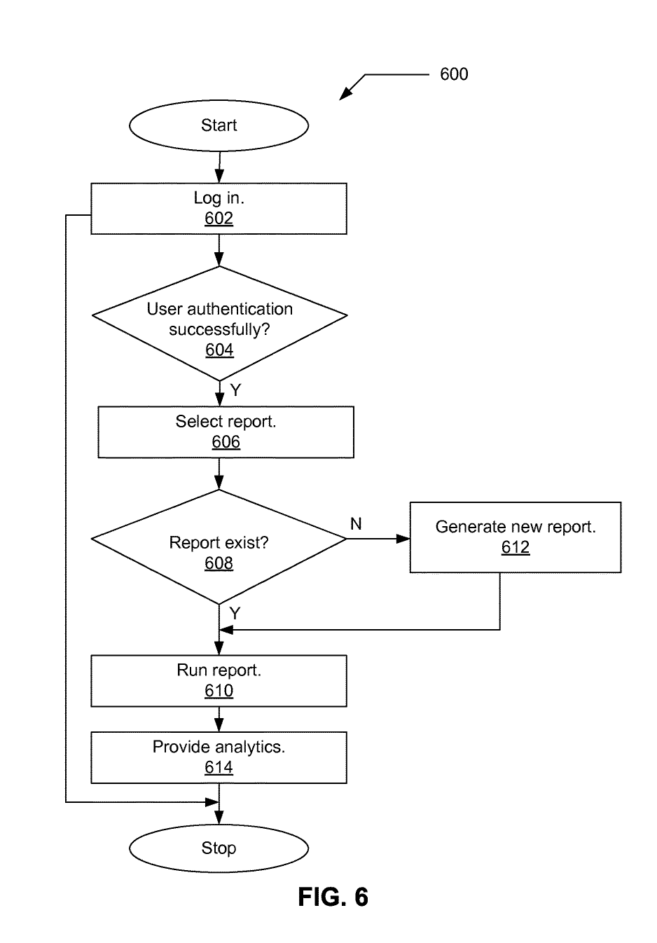

In FIG. 6, a flow diagram 600 of a process of generating reports in the veterinary management system server 102 via analytics module 314 is illustrated in accordance with an example implementation of the invention. A user seeking to run reports logs in 602 at a workstation, such as workstation 114, and is authenticated 604 via the security module 318. If authentication fails, then processing is complete. If authentication is successful, then the user may select a report 606. If the report exists 608, then the report is run 610 via the analytics module 314. If the report does not exist 608, then it is generated 612 using report generation tools. Once generated 612, the report may then be run 610. The resulting report is then provided and will typically contain analytics data in a readily comprehensible format 614.

### Digitization of the Coupon Process

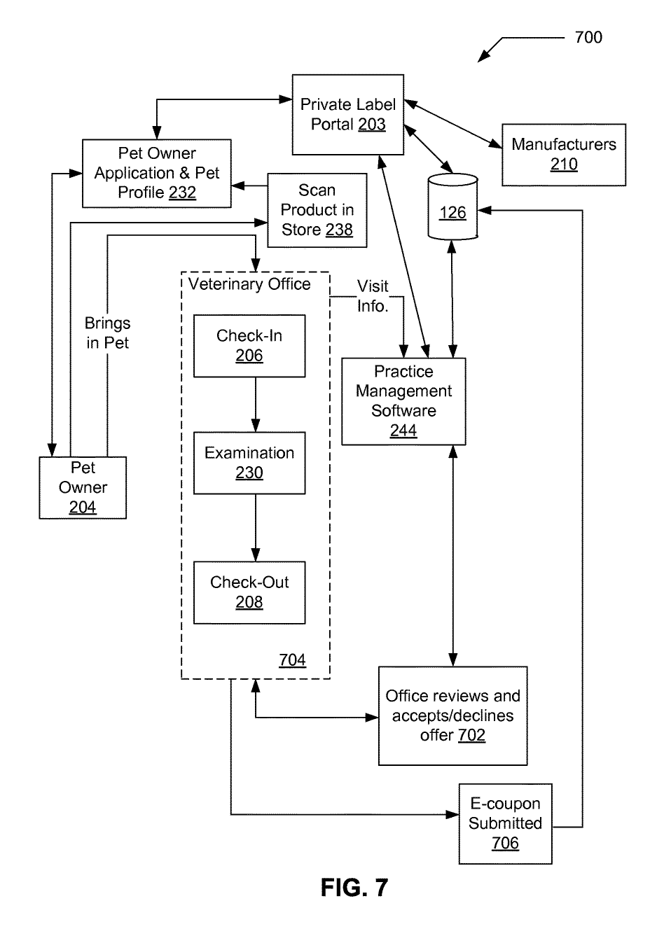

The veterinary management system server 102 is able to connect with manufacturers, pet owners, and the veterinary practice. Unlike the current approaches of manually processing manufacturer's coupons, a digital coupon/rebate approach is now described. In FIG. 7, an illustration 700 of the digital coupon/rebate approach in a veterinary practice with a veterinary management system server 102 of FIG. 1 is illustrated in accordance with an example implementation. Manufacturers 210 may communicate promotions and E-coupons through the private label portal 203. The private label portal 203 may also communicate with the database 126 when receiving digital coupon or rebate information from the manufacturer 210. The manufacturers therefore have the ability to customize the offers or promotions, regionally or by participating veterinary clinic, or by sales territory. Additionally, the offers or promotions may be customized to the pet owner.

The pet owner 204 may access a web site or application on a smart device 232 that enables the pet owner 204 to have access to a pet's profile and the data contained in the veterinary management system server 102. The pet owner application 232 is also able to access the practice management software 244 via the private label portal 203. Such access enables a pet owner 204 to receive targeted and specific, timelier, and relevant promotions, incentives, and E-coupons from the manufacturers 203 and the veterinary practice related to the product, services and medications that their pet is currently taking. Further, a pet owner 204 may set up appointments, and review data and records via the private label portal 203.

The pet owner 204 may bring their pet into the veterinary office 704 for an office visit. The pet owner 204 and their pet may be checked-in 206 by a receptionist who verifies or enters information associated with the pet owner 204 and pet into the practice management software 244 via a workstation (such as workstation 112). A veterinary doctor then proceeds to examine the pet 230. After the examination, the pet owner checks-out 208 prior to leaving the office 704. The receptionist at a workstation is provided with a prompt to make an offer to the pet owner, who can either accept or decline the offer 702. The prompt is generated by the practice management software 244, part of the veterinary management system server that may appear as if it part of the practice management software normal work flow, or prompted to be generated via activities of checking-out using the practice management software. Checking-out may include the activities of invoicing, adding items (modification of the invoice) for products or services, adding items to the invoice from the veterinary's notes that become part of the pet's medical history. The check-out data, such as payment information, services performed, and products purchased may also be passed to the practice management software 244. The data may also be passed via the database to manufacturers, pharmacies with pet products, insurers, specialists, and referral or veterinary management groups.

The veterinary management system server 102 provides the veterinarian and the veterinarian's staff the ability to map their products and services, item codes and names in their practice management software, and then select which of these they would like to prompt on. They are in control of the prompts via a profile and can turn on or off as well as edit the prompt's message(s). Through the veterinary management system server 102 the prompts may be turned on for any service or products that are mapped in their profile (prompt by: code, name, description, quantity). The prompts may also be turned on for service(s) and or product(s) groupings that are mapped.

Prompts may appear at many different steps in the workflow including but not limited to: check-in; during the veterinary exam if related (if is entered paperless in practice management software); during the veterinary notes process or medical record entry process; during the prescription or pharmacy process; and during the check-out or invoicing process or charge storing process. Prompts may be focused or directed on times and situations to remind veterinary staff of best medical practices, protocols, manufacturer recommendations etc . . . Also, prompts are focused on situations where the pet-owning client is present to hear the prompt message and make decisions.

The veterinary management system server 102 may also provide real time, unique, in-depth, and relevant management data reporting related to the interaction that triggered the prompt, including information that is not found in the practice management software. This information includes but is not limited to: exact time of day the prompt launched, the vet user logged in, the client name, pet name and all transactional details of the pet/client visit, including but not limited to, the products and services included in the interaction/transaction, the prompt launched, the pet owner/client's response of “client accepted offer” or “client declined offer.” This information may be used to determine offer effectiveness and maximize revenue. This information may also be used to manage/coach veterinary staff interactions more effectively and to determine veterinary economics in the area of the country the data associated with the prompts are being studied, including pet owner willingness to spend and or their amount of discretionary income (upper limits on pet spending).

An example of an offer would be the receptionist being prompted to up sell the number of heartworm doses (topical, pills, tablets, chewable tablets, or injections) from a three month regime to a twelve month regime. The receptionist then records if the offer was accepted or declined by the pet owner. The veterinary management server system 102 then knows when to prompt the pet owner to buy another regime and which one to offer or attempt to up-sell. Further, if a coupon or rebate is available for the product being purchased by the pet owner, they are able to electronically submit the coupon or rebate 706 via their workstation. The coupon redemption information is then entered into the database 126. The entry of the data may be automatic as all the necessary transactional, pet, pet owner, and clinic information required to process the coupon or offer is present in the veterinary management system server 102.

The pet owner 204 may also take advantage of savings through coupons or rebates available and aligned to pet products by scanning the product in the store where they are being purchased 238. The scanning may involve scanning the product, coupon, or offer and a proof of purchase, such as a receipt. The coupon or rebate, once scanned 238 may be submitted to the veterinary management system server 102 via the pet owner application 232 that enters the information into database 126.

A manufacturer 210 may receive coupon or rebates redemption data at predetermined times (e.g., one a day, one a week, once a month) and the redemption data is being pushed from the veterinary management system server 102 in the current example, but in other implementations the redemption data may be pulled by the manufacturers 210. The described approach eliminates the manual post processing of rebates and coupons that currently takes place in veterinary offices.

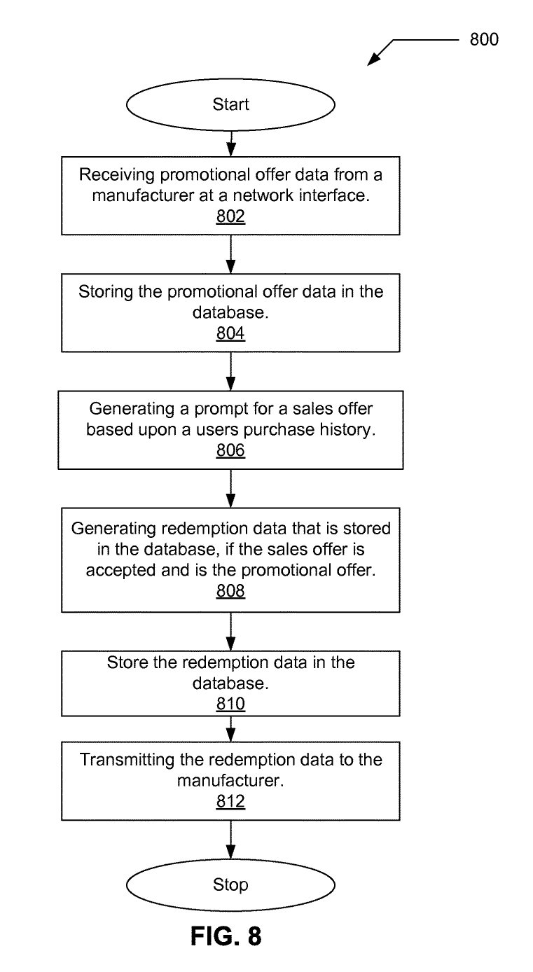

Turning to FIG. 8, a flow diagram 800 of an approach for providing promotional offers to pet owners is illustrated in accordance with an example implementation. A promotional offer, such as a coupon or E-coupon has promotional offer data that is transmitted by the manufacturer and received at a network interface 122 of the veterinary management system server 102 via the private label portal 203 in step 802. The promotional offer data may then be stored in the database 126.

At the conclusion of an office visit the veterinary management system 102 causes a prompt to be generated at a workstation that a receptionist may be using to check-in, process (meaning work in the pet's medicinal history or record for any reason), or check-out a pet owner. The prompt may be for an educational purpose (e.g., improving adherence to recommendations), a sales offer based upon the pet owner's purchase history, or certain items such as products or services selected by the veterinary staff in step 806. If the sales offer is accepted and was also associated with the promotional offer, then redemption data is generated during check-out using both existing data from the database and current transactional data 808. In step 810, the redemption data may then be stored in the database 126. The stored redemption data, in step 812 may then be periodically pushed to the manufacturer via the network interface 122. In other implementations, the manufacture may send an “upload” message to the veterinary management system server 102 that starts the uploading of redemption data.

The pet owner 204 may also receive promotional or sales offers via the private label portal 203 and/or pet owner application 232. The pet owner 204 may create redemption data via the pet owner application 232 or over the internet using the web portal. Once received by the veterinary management system server, the redemption data may then be stored in the database 126 for later transmission to the manufacturer. In other implementations, the redemption data may be transmitted immediately to the manufacturer.

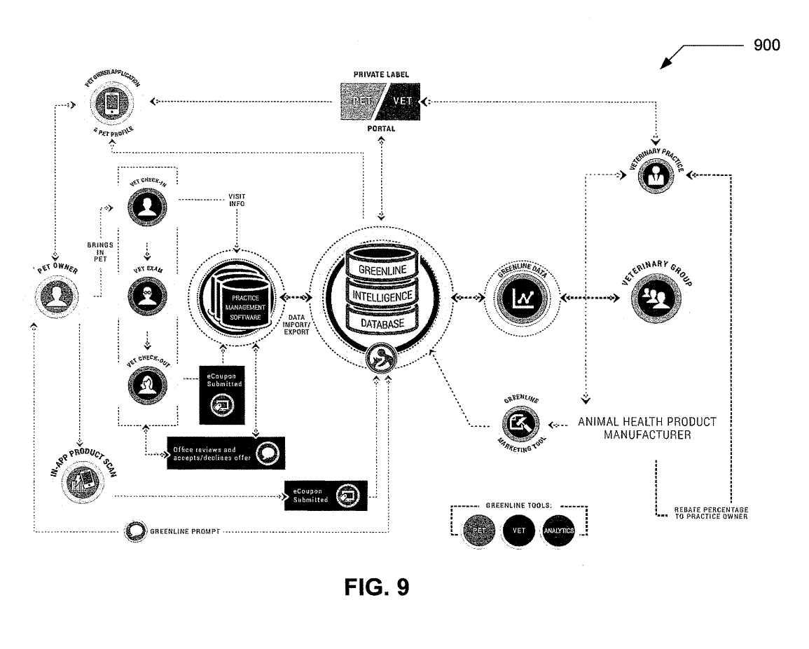

In FIG. 9, an illustration 900 of a commercial implementation of a veterinary management system server 102 of FIG. 1 is illustrated in accordance with an example implementation of the present invention.

### Additional Technical Details

It will be understood and appreciated that one or more of the processes, sub-processes, and process steps described in connection with FIG. 1 may be performed by hardware, software, or a combination of hardware and software on one or more electronic or digitally-controlled devices. The software may reside in a software memory (not shown) in a suitable electronic processing component or system such as, for example, one or more of the functional systems, devices, components, modules, or sub-modules schematically depicted in FIG. 1. The software memory may include an ordered listing of executable instructions for implementing logical functions (that is, “logic” that may be implemented in digital form such as digital circuitry or source code or in analog form such as an analog electrical, sound, or video signal). The instructions may be executed within a processing module, which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the data management system in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A veterinary management system server comprising:
a database able to store promotion redemption data, where the database contains user data in addition to redemption data that are both associated with the user;
an interface adapted for communication with a manufacturer; and
a controller coupled to the database and the interface that stores the promotion redemption data in the database and where the promotion redemption data is redeemable by the manufacturer and periodically transmitted to the manufacturer.

2. The veterinary management system server of claim 1, wherein the user data includes purchase history data and pet data.

3. The veterinary management system server of claim 1, further including receipt of promotion redemption data from a pet owner application.

4. The veterinary management system server of claim 1, further including a workstation that transmits the promotion redemption data for storage in the database.

5. The veterinary management system server of claim 4, where an offer of a product is selected based upon purchase history and displayed on the workstation and if accepted results in the promotion redemption data.

6. The veterinary management system server of claim 1, where the E-coupon redemption data is associated with a promotion created by the manufacturer.

7. The veterinary management system server of claim 1, where the database is an SQL database.

8. A method for a veterinary management system, comprising:
receiving a promotional offer data from a manufacturer at a network interface coupled to a controller;
storing the promotional offer data in a database by the controller, where the database also contains product information data; and
generating a prompt based upon a user's purchase history, where the prompt is a sales offer is for a product associated with the product information data in the database.

9. The method for a veterinary management system of claim 8, where generating a prompt further includes selecting a product that is associated with the promotional offer data.

10. The method for a veterinary management system of claim 9, further including generation of redemption data for redemption of the promotional offer and storing the redemption data in the database, if the sales offer is accepted.

11. The method for a veterinary management system of claim 10, further including transmitting the redemption data to the manufacture.

12. The method for a veterinary management system of claim 11, where transmitting the redemption data further includes pushing the redemption data to the manufacturer via the network interface at predetermined times.

13. The method for a veterinary management system of claim 9, where generating the prompt further includes displaying the prompt on a workstation during check-out.

14. The method for a veterinary management system of claim 9 where generating the prompt further includes displaying the prompt on a smart device.

15. A non-transient computer-readable media containing a plurality of machine-readable instructions, that when executed result in a method for a veterinary management system, comprising the steps of:
receiving a promotional offer data from a manufacture at a network interface coupled to a controller;
storing the promotional offer data in a database by the controller, where the database also contains product information data; and
generating a prompt based upon a user's purchase history, where the prompt is a sales offer is for a product associated with the product information data in the database.

16. The non-transient computer-readable media containing a plurality of machine-readable instructions of claim 16 where generating a prompt further includes selecting a product that is associated with the promotional offer data.

17. The non-transient computer-readable media containing a plurality of machine-readable instructions of claim 16 further including generation of redemption data for redemption of the promotional offer and storing the redemption data in the database, if the sales offer is accepted.

18. The non-transient computer-readable media containing a plurality of machine-readable instructions of claim 17, further including transmitting the redemption data to the manufacture.

19. The non-transient computer-readable media containing a plurality of machine-readable instructions of claim 18, where transmitting the redemption data further includes pushing the redemption data to the manufacturer via the network interface at predetermined times.

20. The non-transient computer-readable media containing a plurality of machine-readable instructions of claim 16, where generating the prompt further includes displaying the prompt on a workstation during check-out.

21. The non-transient computer-readable media containing a plurality of machine-readable instructions of claim 16, where generating the prompt further includes displaying the prompt on a smart device.
